(19) United States
(12) Patent Application Publication
(10) Pub. No.: US 2024/0005036 A1
(43) Pub. Date: Jan. 4, 2024

(54) RESOURCE ACCESS CONTROL METHOD, IMAGE FILE SHARING METHOD, ELECTRONIC APPARATUS AND COMPUTER-READABLE MEDIUM

(71) Applicant: BOE TECHNOLOGY GROUP CO., LTD., Beijing (CN)

(72) Inventors: Qian ZHANG, Beijing (CN); Junjie ZHAO, Beijing (CN)

(21) Appl. No.: 18/039,241

(22) PCT Filed: Nov. 24, 2021
(86) PCT No.: PCT/CN2021/132619

§ 371 Date: May 27, 2023

(30) Foreign Application Priority Data
Nov. 30, 2020 (CN) 202011372227.0

(51) Int. Cl. G06F 21/62

(52) U.S. Cl. CPC G06F 21/6254

(57) ABSTRACT

A resource access control method, including: in response to a modification instruction for a target resource, storing a target resource copy content file (S101), the modification instruction being configured to indicate modification of the target resource; and obtaining a target resource copy according to the target resource copy content file, the target resource copy being a resource obtained by modifying the target resource according to the modification instruction; and in response to an access request for the target resource, providing an access option (S102), the access option including an option for accessing the target resource and an option for accessing the target resource copy. Also provided is an electronic apparatus.

### TECHNICAL FIELD

Embodiments of the present disclosure relate to the field of computer technology, and in particular relates to a resource access control method, an image file sharing method, an electronic apparatus and a computer-readable medium.

### BACKGROUND

Besides information representing actual contents of an image (namely contents of ‘image’ itself), an image file includes other information, for example, exchangeable image file (EXIF) information of the image file may include collection position information, collection time information, lens information used for collection, model information of a collection device (such as a mobile phone) and the like of the image. Such information may be related to personal privacy and may be shared unintentionally together with the image file when the image file is shared (e.g., through instant messaging software), which results in privacy leakage.

In order to avoid privacy leakage, privacy information may be removed when an image file is shared, but the existing removal function is troublesome to operate and has complicated process, which would degrade user experience.

### SUMMARY

Embodiments of the present disclosure provide a resource access control method, an image file sharing method, an electronic apparatus, and a computer-readable medium.

In a first aspect, embodiments of the present disclosure provide a resource access control method, including: in response to a modification instruction for a target resource, storing a target resource copy content file; the modification instruction being configured to indicate modification of the target resource, a target resource copy being obtainable from the target resource copy content file, and the target resource copy being a resource obtained by modifying the target resource according to the modification instruction; and in response to an access request for the target resource, providing an access option including an option for accessing the target resource and an option for accessing the target resource copy.

In some embodiments, the target resource is a multimedia file.

In some embodiments, the multimedia file is an image file; and the modification instruction is configured to indicate modification of an exchangeable image file information in the image file.

In some embodiments, in response to the modification instruction for the target resource, storing the target resource copy content file includes: in response to an access request for the target resource, acquiring the modification instruction for the target resource; and modifying the target resource according to the modification instruction to obtain the target resource copy, accessing the target resource copy, and storing the target resource copy content file.

In some embodiments, storing the target resource copy content file includes: providing a store option including an option for storing the target resource copy content file and an option for not storing the target resource copy content file; and in response to a selection instruction of the option for storing the target resource copy content file, storing the target resource copy content file.

In some embodiments, storing the target resource copy content file includes: determining modification setting for the target resource indicated by the modification instruction, and storing the modification setting as the target resource copy content file.

In some embodiments, storing the target resource copy content file includes: modifying the target resource according to the modification instruction to obtain the target resource copy, and storing the target resource copy as the target resource copy content file.

In some embodiments, the access request for the target resource includes a request for sharing the target resource.

In some embodiments, providing the access option includes: providing an original thumbnail as the option for accessing the target resource, and providing a copy thumbnail as the option for accessing the target resource copy, the original thumbnail including a thumbnail of the target resource, and the copy thumbnail including the original thumbnail and a preset copy mark.

In some embodiments, after providing the access option, the method further includes: in response to a selection instruction of the option for accessing the target resource, requesting for accessing the target resource; or in response to a selection instruction of the option for accessing the target resource copy, accessing the target resource copy.

In some embodiments, in response to the selection instruction of the option for accessing the target resource, requesting for accessing the target resource includes: in response to the selection instruction of the option for accessing the target resource, acquiring the modification instruction for the target resource.

In some embodiments, storing the target resource copy content file includes: determining modification setting for the target resource indicated by the modification instruction, and storing the modification setting as the target resource copy content file; and in response to the selection instruction of the option for accessing the target resource copy, accessing the target resource copy includes: modifying the target resource according to the modification setting to obtain the target resource copy, and accessing the target resource copy.

In a second aspect, embodiments of the present disclosure provide a resource access control method, including: storing a private information-removed copy and associating an original resource with the privacy information-removed copy by a common service entity, wherein a privacy information-removed resource is obtainable from the privacy information-removed copy, and the privacy information-removed resource is obtained by removing privacy information from an original resource; and in response to an access request for the original resource, returning, by the common service entity, an option for accessing the original resource and an option for accessing the privacy information-removed resource.

In some embodiments, storing the private information-removed copy and associating the original resource with the privacy information-removed copy by the common service entity includes: in response to the access request for the original resource from a second application entity and an instruction for reserving the private information-removed copy acquired by a first application entity, acquiring the privacy information-removed resource obtained by the first application entity according to the instruction for reserving the private information-removed copy, returning the privacy information-removed resource to the second application entity, storing the private information-removed copy, and associating the original resource with the private information-removed copy, by the common service entity.

In some embodiments, in response to the access request for the original resource, returning, by the common service entity, the option for accessing the original resource and the option for accessing the privacy information-removed resource includes: in response to the access request for the original resource from a second application entity, returning, by the common service entity, the option for accessing the original resource and the option for accessing the privacy information-removed resource to the second application entity.

In some embodiments, the option for accessing the original resource includes the original resource and/or a resource associated with the original resource; and the option for accessing the privacy information-removed resource includes the privacy information-removed resource and/or a resource associated with the privacy information-removed resource.

In some embodiments, the option for accessing the privacy information-removed resource includes: a virtual privacy information-removed resource and an address of the privacy information-removed resource.

In some embodiments, the option for accessing the privacy information-removed resource includes: the privacy information-removed resource, wherein the privacy information-removed resource includes an address of the privacy information-removed resource and a type of removed privacy information resource.

In some embodiments, after in response to the access request for the original resource, returning, by the common service entity, the option for accessing the original resource and the option for accessing the privacy information-removed resource, the method further includes: in response to selection of the option for accessing the original resource, returning, by the common service entity, the original resource; or in response to selection of the option for accessing the privacy information-removed resource, returning, by the common service entity, the privacy information-removed resource.

In some embodiments, the private information-removed copy includes the privacy information-removed resource; storing the private information-removed copy and associating the original resource with the privacy information-removed copy by the common service entity includes: in response to the access request for the original resource from a second application entity and an instruction for reserving the private information-removed copy acquired by a first application entity, acquiring the privacy information-removed resource obtained by the first application entity according to the instruction for reserving the private information-removed copy, returning the privacy information-removed resource to the second application entity, storing the privacy information-removed resource as the private information-removed copy, and associating the original resource with the private information-removed resource, by the common service entity; and in response to the selection of the option for accessing the privacy information-removed resource, returning, by the common service entity, the privacy information-removed resource includes: in response to the second application entity's selection of the option for accessing the privacy information-removed resource, returning, by the common service entity, the privacy information-removed resource.

In some embodiments, the private information-removed copy includes removal setting in the instruction for reserving the private information-removed copy; and storing the private information-removed copy and associating the original resource with the privacy information-removed copy by the common service entity includes: in response to the access request for the original resource from a second application entity and an instruction for reserving the private information-removed copy acquired by a first application entity, acquiring the privacy information-removed resource obtained by the first application entity according to the instruction for reserving the private information-removed copy, returning the privacy information-removed resource to the second application entity and then deleting the privacy information-removed resource, storing the removal setting in the instruction for reserving the private information-removed copy as the private information-removed copy, and associating the original resource with the removal setting, by the common service entity; and in response to the selection of the option for accessing the privacy information-removed resource, returning, by the common service entity, the privacy information-removed resource includes: in response to the second application entity's selection of the option for accessing the privacy information-removed resource, sending the removal setting to the first application entity, acquiring the privacy information-removed resource which is obtained by the first application entity according the removal setting; returning the privacy information-removed resource to the second application entity and then deleting the privacy information-removed resource, by the common service entity.

In a third aspect, embodiments of the present disclosure further provide an electronic apparatus, including: one or more processors; a memory having one or more computer programs stored thereon; and one or more I/O interfaces coupled between the processor and the memory and configured to realize information interaction between the processor and the memory. When executed by the one or more processors, the one or more computer programs are configured to implement the above resource access control method.

In a fourth aspect, embodiments of the present disclosure provide a computer-readable medium on which a computer program is stored. When executed by a processor the computer program implements any one of the resource access control methods described above.

In a fifth aspect, embodiments of the present disclosure provide an image file sharing method, including: in response to a sharing request for sharing the image file, acquiring a removal instruction, the removal instruction being configured to remove at least part of privacy information in exchangeable image file information of the image file; removing corresponding privacy information in the exchangeable image file information of the image file according to the removal instruction to obtain a privacy information-removed image file, and sharing the privacy information-removed image file; storing a privacy information-removed image file copy, and associating the privacy information-removed image file copy with the image file, wherein the privacy information-removed image file is obtainable from the privacy information-removed image file copy; in response to the sharing request for sharing the image file, providing a sharing option including an option for sharing the image file and an option for sharing the privacy information-removed image file; in response to selection of the option for sharing the image file, sharing the image file; and in response to selection of the option for sharing the privacy information-removed image file, determining the privacy information-removed image file copy associated with the image file, obtaining the privacy information-removed image file according to the privacy information-removed image file copy, and sharing the privacy information-removed image file.

### BRIEF DESCRIPTION OF DRAWINGS

The accompanying drawings, which constitute a part of the specification, are used to provide a further understanding of embodiments of the present disclosure and explain the present disclosure together with the embodiments of the present disclosure, and do not constitute a limitation of the present disclosure. The above and other features and advantages will become more apparent to those skilled in the art by describing in detail example embodiments thereof with reference to the accompanying drawings, in which:

FIG. 1 is a flowchart of a resource access control method according to an embodiment of the present disclosure;

FIG. 2 is a flowchart illustrating partial steps in another resource access control method according to an embodiment of the present disclosure;

FIG. 3 is a flowchart illustrating partial steps in another resource access control method according to an embodiment of the present disclosure;

FIG. 4 is a flowchart illustrating partial steps in another resource access control method according to an embodiment of the present disclosure;

FIG. 5 is a flowchart illustrating partial steps in another resource access control method according to an embodiment of the present disclosure;

FIG. 6 is a flowchart illustrating partial steps in another resource access control method according to an embodiment of the present disclosure;

FIG. 7 is a schematic diagram of an original thumbnail and a copy thumbnail in another resource access control method according to an embodiment of the present disclosure;

FIG. 8 is a flowchart of another resource access control method according to an embodiment of the present disclosure;

FIG. 9 is a flowchart illustrating partial steps in another resource access control method according to an embodiment of the present disclosure;

FIG. 10 is a flowchart of another resource access control method according to an embodiment of the present disclosure;

FIG. 11 is a signaling diagram in another resource access control method according to an embodiment of the present disclosure;

FIG. 12 is a block diagram illustrating components of an electronic apparatus according to an embodiment of the present disclosure;

FIG. 13 is a block diagram illustrating components of a computer-readable medium according to an embodiment of the present disclosure; and

FIG. 14 is a flowchart of an image file sharing method according to an embodiment of the present disclosure.

### DETAIL DESCRIPTION OF EMBODIMENTS

In order to enable one of ordinary skill in the art to better understand the technical solutions of the present disclosure, a resource access control method, an image file sharing method, an electronic apparatus, and a computer-readable medium according to embodiments of the present disclosure will be described in further detail with reference to the accompanying drawings.

The embodiments of the present disclosure will be described more fully hereinafter with reference to the accompanying drawings, but the embodiments shown may be embodied in different forms and should not be construed as limited to the embodiments set forth herein. Rather, these embodiments are provided so that the present disclosure will be thorough and complete, and will fully convey the scope of the present disclosure to those skilled in the art.

The embodiments of the present disclosure may be described with reference to plan and/or cross-sectional views by ideal schematic diagram of the present disclosure. Accordingly, the example illustrations may be modified in accordance with manufacturing techniques and/or tolerances.

The embodiments of the present disclosure and features of the embodiments may be combined with each other without conflict.

The term used in the present disclosure is for the purpose of describing particular embodiments only and is not intended to limit the present disclosure. As used in the present disclosure, the term “and/or” includes any and all combinations of one or more of the associated listed items. As used in the present disclosure, singular forms “a”, “an” and “the” are intended to include plural forms as well, unless the context clearly indicates otherwise. The terms “includes”, “including”, and “made of”, as used in the present disclosure, specify the presence of stated features, integers, steps, operations, elements, and/or components, but do not exclude the presence or addition of one or more other features, integers, steps, operations, elements, components, and/or groups thereof.

Unless otherwise defined, all terms (including technical and scientific terms) used in the present disclosure have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The embodiments of the present disclosure are not limited to the embodiments shown in the drawings, but include modifications of configurations formed based on a manufacturing process. Thus, the regions illustrated in the figures have schematic properties, and the shapes of the regions shown in the figures illustrate specific shapes of regions of elements, but are not intended to be restrictive.

In some related arts, in an image file stored by a device (such as a mobile phone, a computer, etc.), in addition to information representing actual content of an image (i.e., content of the “image” itself), the image file also includes other information, for example, exchangeable image file (EXIF) information of the image file may include collection position information, collection time information, lens information used for collection, model information of a collection device (such as a mobile phone) and the like of the images. It can be seen that the above information may represent some personal privacy, i.e., may include private information.

In some cases, a user may expect to share the image file, such as by sending the image file to another user's devices via an application (e.g., sharing an original image via an instant messaging software). In this case, the user usually expects to share the actual content of the image, but the privacy information is also shared together with the image file, thereby causing unintentional privacy leakage by the user.

In some prior art, to avoid the above privacy leakage, the following safe sharing manner may be adopted.
(1) When an application (such as an instant messaging software) shares an image file in an image library (such as shares original images), a safety detection tool finds that the image file is accessed, and triggers a privacy information removal tool to start working.
(2) The privacy information removal tool prompts and reminds the user to select which privacy information to be removed on the original image file.

For example, the privacy information removal tool may provide a popup window having options such as “remove collection location information”, and “remove collection device model information”, to be selected by the user to determine whether to remove the corresponding information.
(3) The private information removal tool processes the image file according to the user's selections, and deletes or rewrites (rewriting means replacing with other contents such as “null”) corresponding contents in the private information (such as EXIF information) so as to remove the private information.
(4) The privacy information removal tool sends the image file with the privacy information removed to the application to be sent by the application.

According to the above methods, the user has to select each time to remove private information and share it. The operation is troublesome, and the process is complicated, thus degrading the user experience.

Illustratively, when a user B uses a mobile phone, the following cases may occur.

Illustratively, according to an embodiment of the present disclosure, also when a user B uses a mobile phone, the following cases may occur.
(1) The user B takes a photo (image file) by using a camera of the mobile phone.
(2) The user B starts the instant messaging software A, finds a user C, clicks on a sharing album button and selects the thumbnail of the photo which is taken just now.

Since the thumbnail is selected, the privacy information removal tool has not yet started working.
(3) When the user B clicks on the “original image” option and clicks on the “sending” button, the safety detection tool finds that the image file is accessed, and therefore the privacy information removal tool is triggered.
(4) The privacy information removal tool provides a popup window which requests the user B to select which privacy information of the image file to be removed.
(5) The user selects to remove some private information and clicks on “confirm” button; and the privacy information removal tool removes the corresponding privacy information of the image file according to the selection of the user, namely, the EXIF information is rewritten or deleted.
(6) The instant messaging software A sends the photo with the private information removed to the user C.
(7) the user B continues to perform operations such as voice and text chat with the user C.
(8) After some time, the user B wants to send the image that was sent to the user C to a user D, but the chat history about the photo that the user B previously sent to the user C cannot be found.
(9) Therefore, the user B starts the instant messaging software A, finds the user D, clicks on the sharing album button again, selects the photo which is took just now, and clicks on the “original image” button.
(10) Since the image file to be transmitted at this time is still the original image from which the privacy information is not removed, the privacy information removal tool provides a popup window again, and requires the user B to reselect which privacy information is to be removed.

Therefore, according to the method in the related art, for the same image file, the user needs to perform selection operation again to remove the private information and share the image file, every time the user shares the image file, which resulting in that the operation is troublesome, the process is complicated, and thus the consumer experience is reduced.

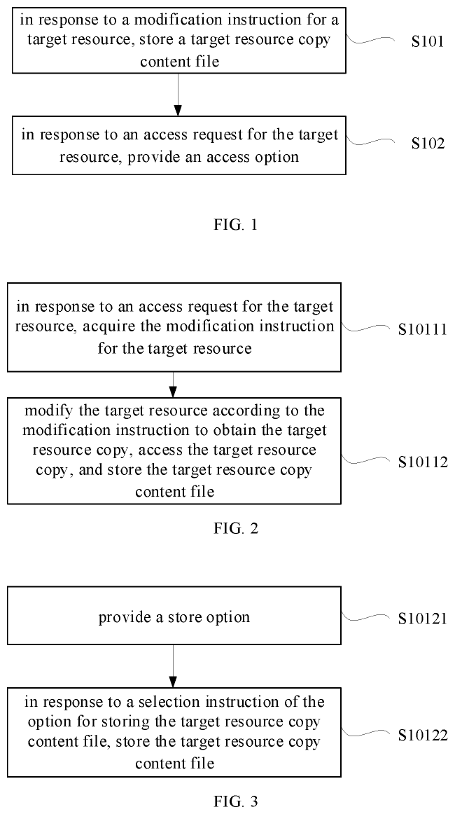

In a first aspect, referring to FIGS. 1 to 9, an embodiment of the present disclosure provides a resource access control method.

The method of the embodiment of the present disclosure is used for controlling the access of resources (such as files) stored in an electronic apparatus (such as a mobile phone, a computer and the like) when the resources are accessed, or developing a corresponding access strategy.

The “access” may be made by an application in the electronic apparatus, or may be made by an operating system of the electronic apparatus; and the “access” may specifically be the use, sharing, duplication, modification, etc. of the resource.

The method of the embodiment of the present disclosure may be performed by one or more of an operating system, an application, and the like of the electronic apparatus, as long as the electronic apparatus as a whole implements the method of the embodiment of the present disclosure.

Referring to FIG. 1, the resource access control method of the embodiment of the present disclosure includes Step 101 and Step 102.

Step S101 includes, in response to a modification instruction for a target resource, storing a target resource copy content file.

The modification instruction is configured to indicate modification of the target resource, a target resource copy can be obtained according to the target resource copy content file, and the target resource copy is the resource obtained by modifying the target resource according to the modification instruction.

When an instruction (modification instruction) requires to modify partial information in a certain resource (target resource), the target resource is modified according to the modification instruction to obtain the target resource copy (namely the target resource still exists, while the target resource copy as modified is obtained) for use, the target resource copy content file is also stored, and the target resource copy may be obtained according to the target resource copy content file.

The above “modification” refers to changing, such as deleting, rewriting, adding, or the like, part of information in the target resource (file).

Step S102 includes in response to an access request for the target resource, providing an access option.

The access option includes an option for accessing the target resource and an option for accessing the target resource copy.

The phrase “providing option” means that the electronic apparatus provides a prompt to a user to select in some ways, so that the user performs selection of some operations according to the prompt. For example, the phrase “providing option” may be a popup window displayed on a display screen of the electronic apparatus, different options in the popup window may be selected by the user, and after the user selects and confirms a certain option, the corresponding selection is performed.

When a request (access request) requires for accessing the target resource again, the access to the target resource is not directly allowed or not allowed, but an “option (access option)” is provided to the user to be selected, so that the user may select for accessing the target resource (the option for accessing the target resource), or select for accessing the target resource copy (the option for accessing the target resource copy) obtained after the original target resource is modified according to the modification instruction.

In an embodiment of the present disclosure, after the target resource (such as the image file) is modified (such as privacy information is removed) to obtain the target resource copy (such as the image file from which privacy information is removed), the target resource copy content file is also stored. Thus, when the target resource is subsequently accessed again (e.g., shared as required), an option may be provided to the user to select whether to still access the target resource or directly access the target resource copy. If the user selects for accessing the target resource copy, the target resource copy can be directly called (the target resource copy is obtained according to the target resource copy content file), so that the user can access the modified target resource (such as the image file with the privacy information removed) without inputting the modification instruction again (such as selection operation), which simplifies operation and process, and improves user experience.

Meanwhile, if the user wants to still access the target resource (the original target resource) or wants to modify the target resource otherwise, the user may select the option for accessing the target resource, so that the access to the resource is more flexible and efficient.

In some embodiments, the target resource is a multimedia file.

In some embodiments, the multimedia file is an image file, and the modification instruction is configured to instruct modification of exchangeable image file information in the image file.

As an implementation of the embodiment of the present disclosure, the above target resource may be a multimedia file, such as a video file, an audio file, or an image file, because the multimedia file often includes private information.

When the multimedia file is in the form of a image file, it may include the exchangeable image file (EXIF) information, the EXIF information is not directly related to the actual content of the image (i.e., the content of the “image” itself), and often contains privacy-related information, and the information is often not desired to be accessed by a user when the actual content of the image file is accessed (e.g., shared), so the modification instruction may be used to modify (e.g., delete or rewrite) the EXIF information.

The “target resource” and the “modification instruction” in the embodiments of the present disclosure are not limited to the above forms. For example, the modification instruction may also be used to modify other types of files in other forms (e.g., modify file names, modify the actual contents of the files, etc.).

In some embodiments, the access request for the target resource includes a request for sharing the target resource.

As an implementation of the embodiments of the present disclosure, the access request for the target resource described above may be a request for “sharing” the target resource, that is, a request for “sending” the target resource to another apparatus (such as a mobile phone).

The user would often like to make the same modification (e.g., remove the same private information) to the resources sent to others, and thus this case is suitable for use of the embodiments of the present disclosure.

The “access request” in the embodiments of the present disclosure is not limited to the above form. For example, the “access request” may also be a request for modifying, deleting, copying a target resource, and the like.

Referring to FIG. 2, in some embodiments, in response to the modification instruction for the target resource, storing of the target resource copy content file (S101) includes Steps S10111 and S10112.

Step S10111 includes in response to the access request for the target resource, acquiring the modification instruction for the target resource.

Step S10112 includes modifying the target resource according to the modification instruction to obtain the target resource copy, accessing the target resource copy, and storing the target resource copy content file.

As an implementation of the embodiments of the present disclosure, the above modification instruction may also be generated when the target resource is accessed; that is, when the target resource is requested to be accessed for the first time, the user may be prompted to input the modification instruction (for example, a popup window is provided by the above privacy information removal tool), so that the target resource copy is obtained by modifying the target resource according to the modification instruction, access to the target resource copy is allowed, and the target resource copy content file is stored.

After that, when the target resource is accessed again, there is a high possibility that the user actually wants to access the target resource copy which is modified in the same way, so that the target resource copy can be obtained by directly using the target resource copy content file, thus simplifying the operation.

Referring to FIG. 3, in some embodiments, storing the target resource copy content file (S101) includes Steps S10121 and S10122.

Step S10121 includes providing a store option.

The store option includes an option for storing the target resource copy content file and an option for not storing the target resource copy content file.

Step S10122 includes in response to a selection instruction of the option for storing the target resource copy content file, storing the target resource copy content file.

As an implementation of the embodiments of the present disclosure, when a user provides the modification instruction, the store option may be further provided to prompt the user whether to store the target resource copy content file, and only when the user selects to store the target resource copy content file, the target resource copy content file is actually stored.

The specific timing and manner of providing the above “store option” may be various.

For example, the above “store option” may be provided for the user to select at the same time when the user is required to input the modification instruction.

For another example, the above “store option” may also be “globally setting”, that is, the user may select the store option from the overall setting options of the operating system of the electronic apparatus, and once the store option is selected, whether to store the target resource copy content file is determined according to the selection in the subsequent processes.

The “store option” may have default selection, and if the user does not change the “store option”, the defaults is “storing the target resource copy content file”.

It is also possible that, if there is no “store option” above, the target resource copy content files are all stored by default.

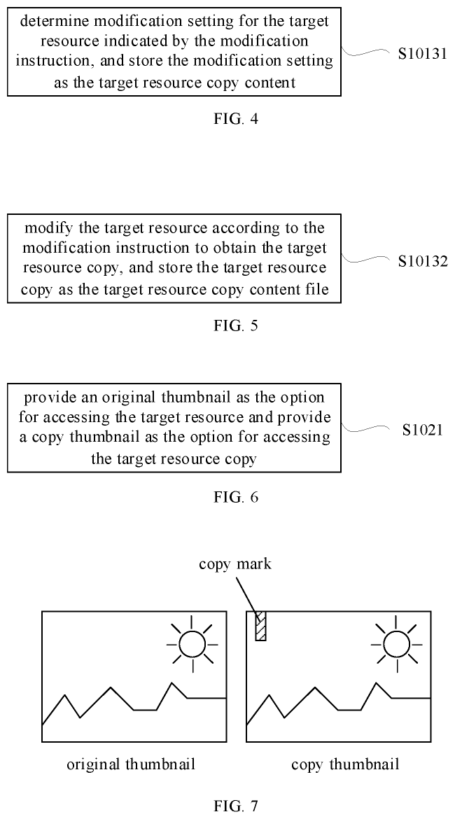

Referring to FIG. 4, in some embodiments, storing the target resource copy content file (S101) includes Step S10131 of determining the modification setting of the target resource indicated by the modification instruction, and storing the modification setting as the target resource copy content file.

As an implementation of the embodiments of the present disclosure, the “target resource copy content file” stored above may be the modification setting (or “modification manner”) for the target resource in the modification instruction, and the target resource copy actually obtained by modifying at this time may be deleted.

According to the above implementation, the “target resource copy content file” does not include the target resource copy after actual modification, but only has some modification settings, so that the occupied storage space is reduced, and the storage space can be saved.

Referring to FIG. 5, in some embodiments, storing the target resource copy content file (S101) includes Step S10132 of modifying the target resource according to the modification instruction to obtain the target resource copy, and storing the target resource copy as the target resource copy content file.

As another implementation of the embodiments of the present disclosure, the target resource copy content file may be obtained by modifying the target resource to obtain the target resource copy and storing the target resource copy as the target resource copy content file.

According to the above implementation, when the target resource copy is expected to be accessed subsequently, the modification operation is not needed, and the target resource copy (also the target resource copy content file) is directly accessed, so that the operation resource can be saved.

Referring to FIG. 6, in some embodiments, providing the access option (S102) includes Step S1021 of providing an original thumbnail as the option for accessing the target resource and providing a copy thumbnail as the option for accessing the target resource copy.

The original thumbnail includes a thumbnail of the target resource, and the copy thumbnail includes the original thumbnail and a preset copy mark.

As an implementation of embodiments of the present disclosure, the access option provided when the target resource is accessed again may be the thumbnail of the target resource (original thumbnail) and the thumbnail of the target resource copy (copy thumbnail). Referring to FIG. 7, the original thumbnail may be a thumbnail of the target resource obtained in a conventional manner, and the copy thumbnail is obtained by adding a specific copy mark (e.g., a rectangle having section lines in FIG. 7) to the original thumbnail, so as to distinguish the target resource copy from the target resource.

It is also possible that the option for accessing the target resource and the option for accessing the target resource copy are in other forms, such as a text description.

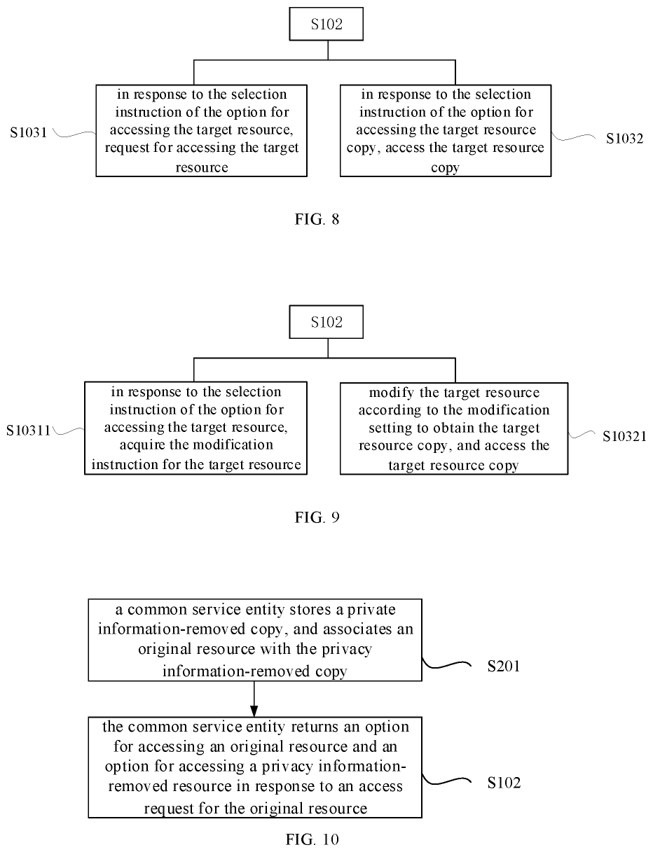

Referring to FIG. 8, in some embodiments, after providing the access option (S102), the method further includes Step S1031 of in response to the selection instruction of the option for accessing the target resource, requesting for accessing the target resource; or Step S1032 of in response to the selection instruction of the option for accessing the target resource copy, accessing the target resource copy.

After the above access options are provided, the target resource or the target resource copy may be accessed correspondingly according to the selection of the user.

If the user wants to access the target resource copy, the corresponding target resource copy may be directly obtained according to the target resource copy content file for access, so that the user does not need to input the modification instruction again, the operation can be simplified, and the user experience is improved.

If the user still wants to access the original target resource, the user only needs to select the option for accessing the target resource, so that the flexibility of the access control method of the embodiments of the present disclosure can be ensured.

Referring to FIG. 9, in some embodiments, in response to the selection instruction of the option for accessing the target resource, requesting for accessing the target resource (S1031) includes: Step S10311 of in response to the selection instruction of the option for accessing the target resource, acquiring the modification instruction for the target resource.

If the user expects to access the target resource later, which is equivalent to a request for re-accessing the target resource, the modification instruction for the target resource may be acquired again (for example, the popup window is provided by the privacy information removal tool above), so that the user may perform other modifications on the target resource, and different target resource copy content files are obtained according to the modifications, thereby further improving the flexibility of the access control method of the embodiments of the present disclosure.

When the user desires to access the target resource later, the user may directly access the target resource without modifying the target resource again.

Referring to FIG. 9, in some embodiments, in a case where the step of storing the target resource copy content file (S101) includes determining the modification setting of the target resource indicated by the modification instruction, and storing the modification setting as the target resource copy content file (S10131), the step of in response to the selection instruction of the option for accessing the target resource copy, accessing the target resource copy (S1032) includes: Step S10321 of modifying the target resource according to the modification setting to obtain the target resource copy, and accessing the target resource copy.

When the target resource copy content file is the above modification setting, if the user desires to access the target resource copy later, the user needs to actually modify the target resource again according to the modification setting to obtain the target resource copy (because the previous target resource copy is deleted) for access.

Illustratively, according to an embodiment of the present disclosure, when the user B uses a mobile phone, the following cases may occur.
(1) The user B takes a photo (image file) by using the camera of the mobile phone.
(2) The user B starts the instant messaging software A, finds the user C, clicks on the sharing album button and selects the thumbnail of the photo which is taken just now.

Since the thumbnail is selected, the privacy information removal tool has not yet started working.
(3) When the user B clicks on the “original image” option and clicks on the “sending” button, the safety detection tool finds that the image file is accessed, and therefore the privacy information removal tool is triggered.
(4) The privacy information removal tool provides a popup window which requires the user B to select which privacy information of the image file is to be removed; meanwhile, according to an embodiment of the present disclosure, the popup window further includes an option for “reserving the private information-removed copy”.

The implementation of the option for “reserving the private information-removed copy” popped up in this case is only exemplary. For example, it is also possible to select whether or not to reserve the private information-removed copy in the “global setting”, so that the option for “reserving the private information-removed copy” does not pop up each time an individual image is processed.

Alternatively, the setting may not be performed, and “reserving the private information-removed copy” is default, so that no corresponding option exists.
(5) The user selects and removes some privacy information, and selects the option for “reserving the private information-removed copy”, and then clicks on “confirm”; the privacy information removal tool removes the corresponding privacy information of the image file according to the selection of the user, namely, the EXIF information is rewritten or deleted, and the image (copy) with the privacy information removed is stored.
(6) The instant messaging software sends the photo with the private information removed to the user C.
(7) The user B continues to perform voice, text chat and other operations with the user C.
(8) After some time, the user B wants to send the image that was sent to user C to a user D, but the chat history about the photo that the user B previously sent to user C cannot be found.
(9) Therefore, the user B starts the instant messaging software A, finds the user D, clicks on the sharing album button again, and selects the photo which is taken just now.
(10) Since the option for “reserving the private information-removed copy” was previously selected, referring to FIG. 7, two thumbnails appear at this time, one being the original thumbnail, representing that it is desired to access the original image file, and the other being a thumbnail with a copy mark, representing that it is desired to access the copy.

Therefore, by above “copy mark”, a user may clearly distinguish whether the photo is processed by the privacy information removal tool, if so, the user may directly select the thumbnail with the copy mark to send the image without performing the removing setting, and the privacy information removal tool does not need to process the image again. Therefore, the operation can be simplified, and the user experience can be improved.

The user may also select the thumbnail of the original image to send the original image file to the other party, or remove the privacy information differently again, so as to ensure the flexibility of the embodiments of the present disclosure.

The particular form of when the option for selecting the original image or copy is provided is also varied. For example, the above options may appear after the user clicks on the “original image” option. In general, it is possible to provide the above options to determine whether the user expects to access the original image or the copy after the user has an intention to access the original image, but before actually accesses the original image.

In a second aspect, referring to FIGS. 10 to 11, an embodiment of the present disclosure provides a resource access control method.

According to the existing oneM2M standard, a common service entity (CSE) may set “conditions (arc)” for accessing resources deployed in a container, such as:
(1) someone (a user) who may access the resource, arc (1);
(2) a certain time for accessing the resource, arc (2);
(3) a certain IP address for accessing the resource, arc (3);
(4) some information in the resource that may be accessed (such as creation time information), arc (4);
(5) certain environmental conditions for accessing the resource (e.g., room temperature below 25 degree centigrade), arc (5);
(6) a certain number of times the resource may be accessed, arc (6);
(7) someone (a user) may access a resource having a certain class (e.g., “AE” class), arc (7).

The specific conditions which need to be satisfied for the access may be one or more of the above, i.e., arcs={arc(1), arc(2), arc(3) . . . }.

As can be seen, although numerous access conditions may be set, the existing oneM2M standard cannot implement the resource access control method of the embodiments of the present disclosure.

Therefore, the embodiments of the present disclosure further provide an access control method (or a method for developing an access strategy) for a resource (such as an image file) stored in a container based on oneM2M standard.

Referring to FIG. 10, a resource access control method according to an embodiment of the present disclosure includes Steps S201 and S202.

In Step S201, the common service entity stores the private information-removed copy, and associates the original resource with the privacy information-removed copy.

The privacy information-removed resource may be obtained according to the private information-removed copy, and the privacy information-removed resource is obtained by removing the privacy information from the original resource.

In Step S202, the common service entity returns the option for accessing the original resource and the option for accessing the privacy information-removed resource in response to the access request for the original resource.

The “original resource” refers to an unmodified resource originally stored in the container, such as an image file with private information.

The “privacy information-removed resource” refers to a resource without privacy information, obtained by removing the privacy information from the original resource.

The content of the “private information-removed copy” is related to the “privacy information-removed resource”, so that the “privacy information-removed resource” can be obtained according to the “private information-removed copy”.

In the embodiment of the present disclosure, the private information-removed copy is stored and associated with the original resource, so that when the original resource needs to be accessed again in the subsequent process, the common service entity (CSE) can provide an option according to the above “association”, and thus the user can select whether to access the original resource or access the privacy information-removed resource. If the user selects to access the privacy information-removed resource, the privacy information-removed resource can be directly obtained according to the privacy information-removed copy for the user to access, without requiring the user to input relevant instruction again, which simplifies the operation and improves the user experience.

In some embodiments, the common service entity storing the private information-removed copy, and associates the original resource with the privacy information-removed copy includes the following step.

In response to an access request for the original resource from a second application entity and an instruction for reserving the private information-removed copy acquired by a first application entity, the common service entity acquires the privacy information-removed resource obtained by the first application entity according to the instruction for reserving the private information-removed copy, returns the privacy information-removed resource to the second application entity, stores the private information-removed copy, and associates the original resource with the private information-removed copy.

The “instruction for reserving the private information-removed copy” is configured to indicate how to remove the privacy information of the original resource to obtain the privacy information-removed resource, and indicate to reserve the private information-removed copy.

The instruction for reserving the private information-removed copy may be acquired by the first application entity (e.g., a privacy information removal tool) based on a request for the original resource from the second application entity (e.g., an application) and the privacy information-removed resource may be generated based on the instruction, and the common service entity may send the privacy information-removed resource to the second application entity and store the private information-removed copy.

In some embodiments, returning the option for accessing the original resource and the option for accessing the privacy information-removed resource in response to the access request for the original resource by the common service entity includes: by the common service entity, returning the option for accessing the original resource and the option for accessing the privacy information-removed resource to the second application entity in response to the access request for the second application entity to the original resource.

A next access request for the original resource may be issued by the second application entity.

In some embodiments, the option for accessing the original resource includes the original resource, and/or a resource associated with the original resource.

The option for accessing the privacy information-removed resource includes the privacy information-removed resource and/or a resource associated with the privacy information-removed resource.

The above option for accessing the original resource and the option for accessing the privacy information-removed resource may include the corresponding resource itself (original resource or privacy information-removed resource), or may include resources associated with the corresponding resource, such as a thumbnail of the corresponding resource (e.g., a thumbnail of the original resource or a thumbnail of the privacy information-removed resource, etc.), etc.

In some embodiments, the option for accessing the privacy information-removed resource includes: a virtual private information-removed resource and an address of the private information-removed resource.

In some embodiments, the option for accessing the privacy information-removed resource includes: the private information-removed resource; the privacy information-removed resource includes an address of the privacy information-removed resource and a type of removed privacy information resource.

As an implementation of the embodiments of the present disclosure, the privacy information-removed resource in the returned option for accessing privacy information-removed resource may be an actual resource or a virtual resource.

When the privacy information-removed resource in the option for accessing privacy information-removed resource is an actual resource, the resource includes the type of removed privacy information resource in addition to the address of the resource, and the items of privacy information that are actually removed are recorded in “the type of removed privacy information resource”.

In some embodiments, the method further includes: after returning, by the common service entity, the option for accessing the original resource and the option for accessing the privacy information-removed resource in response to the access request for the original resource, returning, by the common service entity, the original resource in response to the selection of the option for accessing the original resource, or returning, by the common service entity, the privacy information-removed resource in response to the selection of the option for accessing the privacy information-removed resource.

After the common service entity returns the option for accessing the original resource and the option for accessing the privacy information-removed resource, the original resource or the privacy information-removed resource can be actually provided as needed, so that the flexibility of method according to the embodiment of the present disclosure can be improved.

If the original resource is returned, the instruction for reserving the private information-removed copy may be obtained again so as to remove the privacy information in the original resource variously and store various privacy information copies.

It is also possible to return the original resource directly.

In some embodiments, the private information-removed copy includes the privacy information-removed resource.

The step of storing the private information-removed copy and associating the original resource with the privacy information-removed resource by the common service entity includes: in response to the access request for the original resource from the second application entity and the instruction for reserving the private information-removed copy, which is acquired by the first application entity, acquiring the privacy information-removed resource, which is obtained by the first application entity according to the instruction for reserving the private information-removed copy, returning the privacy information-removed resource to the second application entity, storing the privacy information-removed resource as the private information-removed copy, and associating the original resource with the privacy information-removed resource, by the common service entity.

The step of returning the privacy information-removed resource in response to the selection of the option for accessing privacy information-removed resource by the common service entity includes: returning the privacy information-removed resource by the common service entity in response to the second application entity's selection of the option for accessing the privacy information-removed resource.

As an implementation of the embodiment of the present disclosure, the private information-removed copy may be the privacy information-removed resource, so that when the common service entity returns the privacy information-removed resource, the common service entity may directly return the corresponding resource.

In some embodiments, the private information-removed copy includes removal setting in the instruction for reserving the private information-removed copy.

The step of storing the private information-removed copy and the associating the original resource with the private information-removed copy by the common service entity includes: in response to the access request for the original resource from the second application entity and the instruction for reserving the private information-removed copy, which is acquired by the first application entity, acquiring the privacy information-removed resource, which is obtained by the first application entity according to the instruction for reserving the private information-removed copy, returning the privacy information-removed resource to the second application entity and then deleting the privacy information-removed resource, storing the removal setting in the instruction for reserving the private information-removed copy as the private information-removed copy, and associating the original resource with the removal setting, by the common service entity.

The step of returning, by the common service entity, the privacy information-removed resource in response to the selection of the option for accessing privacy information-removed resource includes: sending the removal setting to the first application entity, acquiring the privacy information-removed resource which is obtained by the first application entity according to the removal setting, returning the privacy information-removed resource to the second application entity and then deleting the privacy information-removed resource, in response to the second application entity's selection for the option for accessing the privacy information-removed resource, by the common service entity.

As another implementation of the embodiment of the present disclosure, the private information-removed copy may also be the removal setting (that is, an instruction indicating how to remove the privacy information) in the instruction for the private information-removed copy. Therefore, after the common service entity sends the privacy information-removed resource to the second application entity, it needs to delete privacy information-removed resource, and only store the “removal setting” as the private information-removed copy. When the common service entity wants to return the privacy information-removed resource, the first application entity needs to generate the privacy information-removed resource again according to the “removal setting” (of course, the resource is deleted again after returning).

In some embodiments, referring to FIG. 11, a private information removal tool for removing the private information (e.g., EXIF information) in a resource (e.g., an image file) serves as the first application entity (AE1), an application (e.g., an instant messaging software) that needs to access (e.g., share) the resource serves as the second application entity (AE2), and the common service entity (CSE) manages the resource in a container.

Referring to FIG. 11, in some embodiments, the access control method according to the embodiments of the present disclosure may specifically include the following steps.
(1) The application (AE2) requests a thumbnail of a resource, i.e., a thumbnail of an original resource, according to a user instruction.
   That is, AE2 requests <contentInstance> (thumbnail).
(2) The common service entity (CSE) returns the thumbnail of the original resource according to the above request.
   That is, CSE returns <contentInstance> (thumbnail).
(3) AE2 requests the original resource according to a user instruction (e.g., the user clicks on the “original image” button).
   That is, AE2 requests <contentInstance> (original image).
   Obviously, in the CSE, the above resources of <contentInstance> original image and <contentInstance)> thumbnail are associated.
(4) As the original resource is accessed, the private information removal tool (AE1) starts working, acquires (e.g., provides a popup window) the instruction for reserving the private information-removed copy input by the user, and requests the original resource from the CSE.
   That is, AE1 requests <contentInstance> (original image).
(5) CSE returns the original resource to AE1 according to the above request.
   That is, CSE returns <contentInstance> (original image).
(6) AE1 (privacy information removal tool) removes corresponding privacy information in the received original resource according to the instruction for reserving the private information-removed copy to obtain the “privacy information-removed resource”, returns the “privacy information-removed resource” to the CSE, and CSE creates the “privacy information-removed resource”.
   That is, AE1 requires the creation of a new <contentInstance> (image with the private information removed).
(7) CSE creates a new resource, returns a successful creation response to AE1, and stores and associates the private information-removed copy (e.g., the privacy information-removed resource) with the original resource.
   That is, CSE returns the successful creation response (image with the private information removed).

Therefore, CSE actually stores the private information-removed copy (such as the privacy information-removed resource), the original resource and the thumbnail of the original resource as resources, and establishes a relationship therebetween.

For example, the storage form for the private information-removed copy, the original resource and the thumbnail of the original resource in CSE may be:

CSE may also create and store the thumbnail of the privacy information-removed resource, and the thumbnail of the privacy information-removed resource is obviously associated with the privacy information-removed resource, so that the privacy information-removed resource, the original resource, the thumbnail of the original resource and the thumbnail of the privacy information-removed resource may be associated with each other.

Referring to FIG. 7, the thumbnail of the privacy information-removed resource may be the thumbnail of the original resource added with a preset copy mark.
(8) CSE returns the privacy information-removed resource to AE2 for use (e.g., sharing) by AE2.
   That is, CSE returns <contentInstance> (image with the private information removed).

If the private information-removed copy is a setting in the instruction for reserving the private information-removed copy related to removing the preset private information, CSE stores the “content” (removal setting), and CSE should delete the image with the private information removed after sending it to AE2.
(9) After a period of time, the user re-uses the application (AE2) and requests access to (e.g., re-shares) the original resource again, so AE2 requests the thumbnail of the original resource from CSE again.
   That is, AE2 requests <contentInstance> (thumbnail).
(10) Since the association has been previously established, CSE may find that there is the resource associated with the thumbnail of the original resource, i.e., the original resource and the private information-removed copy (e.g., the private information-removed resource), and also the thumbnail of the private information-removed resource.

Thus, CSE may return a response of the thumbnail of the original resource (an option for accessing the original resource) and a response of the thumbnail having a copy mark (an option for accessing privacy information-removed resource) to AE2.

That is, CSE returns <contentInstance> (thumbnail) and returns <contentInstance> (thumbnail) (with copy mark) (i.e., “response A”).

As an implementation of the embodiment of the present disclosure, the above response of the thumbnail with the copy mark (i.e., response A) returned by CSE may include: a content instance resource of the thumbnail with a copy mark (<contentInstance> resource of the thumbnail with the copy mark, a virtual privacy information-removed resource (virtual resource <personalInforRemoved>), and an address of the privacy information-removed resource (an actual address of the associated privacy information removed-resource).

That is, the content (content) of the response returned by CSE to AE2 may include the “virtual resource” corresponding to the privacy information-removed resource, and also include the address of the actual privacy information-removed resource. Therefore, in the subsequent response B (i.e., the response that AE2 requests for the private information-removed resource to CSE), it may request to acquire the resource at the corresponding address.

As another implementation of the embodiment of the present disclosure, the above response of the thumbnail with the copy mark (i.e., response A) returned by CSE may include: a content instance resource of the thumbnail with a copy mark (<content instance> resource of the thumbnail with a copy mark), a privacy information-removed resource (resource <personalInforRemoved>), and the resource <personalInforRemoved> includes an address of an actual privacy information-removed resource (personalInfoRemovedResourceAddress), and a type of the removed privacy information resource (personalInfoRemovedType).

The type of the removed privacy information resource (personalInfoRemovedType) indicates which items of privacy information are removed, such as locationInfo (collection position information of an image), lensInfo (information of a lens used for collection), CameraInfo (model information of a collection device), allExifInfo (all privacy information), and the like.

Therefore, in the subsequent response B (i.e., the response that AE2 requests for the private information-removed resource to CSE), it may request to acquire the resource at the corresponding address.

That is, the content of the response returned to AE2 by CSE may also have the actual privacy information-removed resource and the address of the corresponding resource.

It is also possible that above response does not include the content instance resource of thumbnail with the copy mark, and AE2 may specifically “double render” the thumbnail of the original resource and add a “copy mark” to one of them as the thumbnail with the copy mark.

CSE may return the two thumbnails at different times, for example, when AE2 requests for the original resource (e.g., selects the “original image” option), the two thumbnails may be returned.
(11) AE2 receives a user selection of the thumbnail with the copy mark to request for the private information-removed resource from CSE.
   That is, AE2 requests <contentInstance> (original image)(with copy mark) (i.e., “response B”).
(12) CSE may find the privacy information-removed resource and return it to AE2.
   That is, CSE returns <contentInstance> (image with private information removed).

If the private information-removed copy is the removal setting, AE1 obtains the privacy information-removed resource again according to the removal setting for the privacy information at this time, and sends the privacy information-removed resource to CSE, and CSE sends the privacy information-removed resource to AE2.

Therefore, according to the embodiment of the present disclosure, when a user removes private information of a certain resource and wants to reuse the privacy information-removed resource, the user can directly call the privacy information-removed resource through association performed by the CSE and the copy mark on the thumbnail without inputting an instruction again, so that the operation and the process are simplified, and the user experience is improved.

Meanwhile, if the user wants to still access the original resource or wants to remove other privacy information in the original resource, the user can also select to access the original resource, so that the access to the resource is more flexible and efficient.

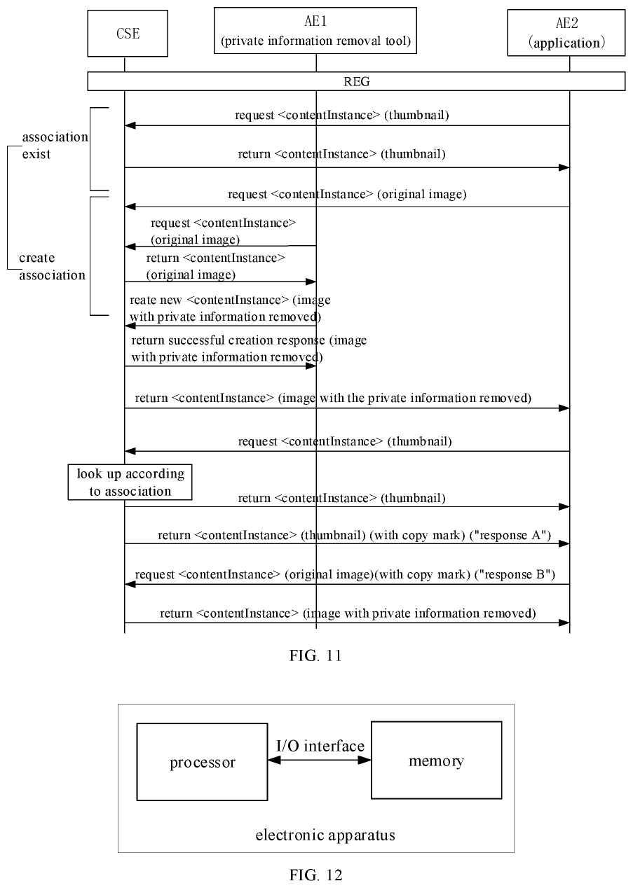

In a third aspect, referring to FIG. 12, an embodiment of the present disclosure provides an electronic apparatus, including: one or more processors; a memory having one or more computer programs stored thereon; one or more I/O interfaces coupled between the processor and the memory and configured to realize information interaction between the processor and the memory, and any of the resource access control methods described above may be implemented, when one or more computer programs are executed by one or more processors.

The processor is a device with data processing capability, which includes but is not limited to a central processing unit (CPU) and the like; the memory is a device with data storage capability including, but not limited to, Random Access Memory (RAM, more specifically SDRAM, DDR, etc.), Read Only Memory (ROM), Electrically Erasable Programmable Read Only Memory (EEPROM), or flash memory (FLASH); an I/O interface (read/write interface) is coupled between the processor and the memory, and may realize information interaction between the memory and the processor, which includes but is not limited to a data bus (Bus) and the like.

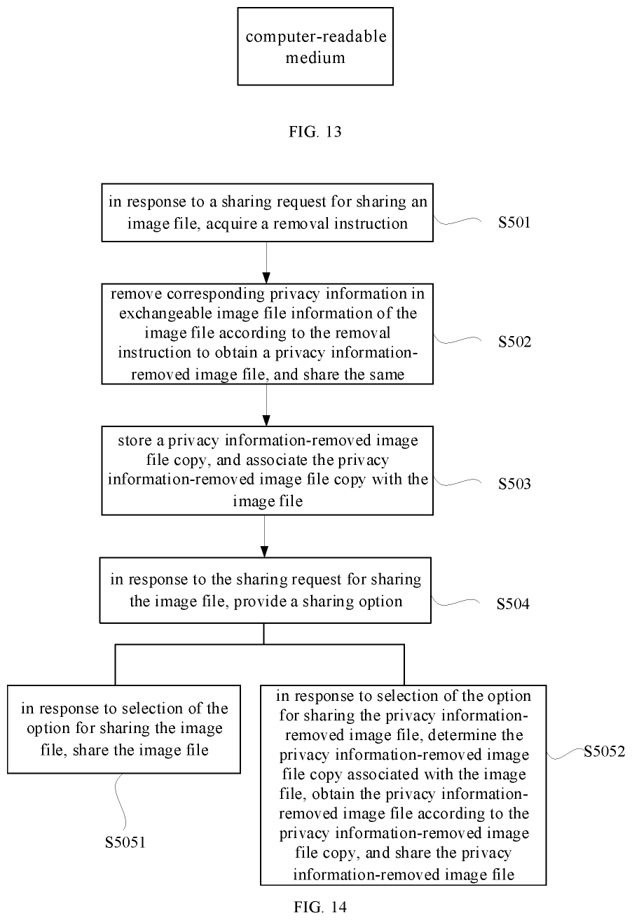

In a fourth aspect, with reference to FIG. 13, an embodiment of the present disclosure provides a computer-readable medium, on which a computer program is stored, and the computer program, when executed by a processor, implements any one of the resource access control methods described above.

In a fifth aspect, referring to FIG. 14, an embodiment of the present disclosure provides an image file sharing method, including Steps 501 to 504 and Steps S5051 and S5052.

Step S501 includes in response to a sharing request for sharing an image file, acquiring a removal instruction.

The removal instruction is used for removing at least part of privacy information in exchangeable image file information of the image file.

Step S502 includes obtaining a privacy information-removed image file by removing corresponding privacy information in the exchangeable image file information of the image file according to the removal instruction, and sharing the privacy information-removed image file.

Step S503 includes storing a privacy information-removed image file copy, and associating the privacy information-removed image file copy with the image file.

The privacy information-removed image file may be obtained according to the privacy information-removed image file copy.

For example, the privacy information-removed image file copy may be the above the privacy information-removed image file; alternatively, the privacy information-removed image file copy may also be the above removal instruction.

Step S504 includes, in response to the sharing request for sharing the image file, providing a sharing option.

The sharing option includes an option for sharing the image file and an option for sharing the privacy information-removed image file.

When the image file required to be shared has an associated privacy information-removed image file copy, a corresponding sharing option is provided.

For example, the option for sharing the image file and the option for sharing the privacy information-removed image file may be two thumbnails of the image file, respectively, and the thumbnail corresponding to the option for sharing the privacy information-removed image file includes a preset copy mark. The user may select the corresponding option by clicking on a certain thumbnail.

Step S5051 includes in response to selection of the option for sharing the image file, sharing the image file.

When the user selects the option for sharing the image file, the image file is directly shared.

Step S5052 includes in response to selection of the option for sharing the privacy information-removed image file, determining the privacy information-removed image file copy associated with the image file, obtaining the privacy information-removed image file according to the privacy information-removed image file copy, and sharing the privacy information-removed image file.

When the user selects the option for sharing the privacy information-removed image file, the privacy information-removed image file is obtained at least according to the corresponding privacy information-removed image file copy, and the privacy information-removed image file is shared.

For example, if the privacy information-removed image file copy is the above privacy information-removed image file, the privacy information-removed image file copy may directly serve as the privacy information-removed image file; if the privacy information-removed image file copy is the above removal instruction, the privacy information-removed image file may be obtained by removing the privacy information from the image file according to the removal instruction.

It should be understood that the order in which the above Steps S5051 and S5052 are described does not represent the order in which the Steps S5051 and S5052 are performed.

One of ordinary skill in the art will appreciate that all or some of the steps, systems, functional modules/units in the devices, disclosed above may be implemented as software, firmware, hardware, and suitable combinations thereof.

In a hardware implementation, the division between functional modules/units mentioned in the above description does not necessarily correspond to the division of physical components; for example, one physical component may have multiple functions, or one function or step may be performed by several physical components in cooperation.

Some or all of the physical components may be implemented as software executed by a processor, such as a central processing unit (CPU), a digital signal processor, or a microprocessor, or as hardware, or as an integrated circuit, such as an application specific integrated circuit. Such software may be distributed on computer-readable medium, which may include computer storage medium (or non-transitory medium) and communication medium (or transitory medium). The term computer storage medium includes volatile and nonvolatile, removable and non-removable medium implemented in any method or technology for storage of information such as computer-readable instructions, data structures, program modules or other data, as is well known to those skilled in the art. Computer storage medium includes, but is not limited to, random access memory (RAM, more specifically SDRAM, DDR, etc.), Read Only Memory (ROM), Electrically Erasable Programmable Read Only Memory (EEPROM), flash memory (FLASH), or other disk storage; Compact Disk Read Only Memory (CD-ROM), Digital Versatile Disk (DVD), or other optical disk storage; magnetic cassettes, magnetic tape, magnetic disk storage or other magnetic storage; any other medium which may be used to store the desired information and which may be accessed by a computer. In addition, communication medium typically includes computer-readable instructions, data structures, program modules or other data in a modulated data signal such as a carrier wave or other transport mechanism and includes any information delivery medium as is well known to those skilled in the art.

The present disclosure has disclosed example embodiments, and although specific terms are employed, they are used and should be interpreted in a generic and descriptive sense only and not for purposes of limitation. In some instances, features, characteristics and/or elements described in connection with a particular embodiment may be used alone or in combination with features, characteristics and/or elements described in connection with other embodiments, unless expressly stated otherwise, as would be apparent to one skilled in the art. It will, therefore, be understood by those skilled in the art that various changes in form and details may be made therein without departing from the scope of the present disclosure as set forth in the appended claims.

1. A resource access control method, comprising:
in response to a modification instruction for a target resource, storing a target resource copy content file, wherein the modification instruction is configured to indicate modification of the target resource, a target resource copy is obtainable from the target resource copy content file, and the target resource copy is a resource obtained by modifying the target resource according to the modification instruction; and
in response to an access request for the target resource, providing an access option comprising an option for accessing the target resource and an option for accessing the target resource copy.

2. The method of claim 1, wherein
the target resource is an image file; and
the modification instruction is configured to indicate modification of an exchangeable image file information in the image file.

3. (canceled)

4. The method of claim 1, wherein in response to the modification instruction for the target resource, storing the target resource copy content file comprises:
in response to an access request for the target resource, acquiring the modification instruction for the target resource; and
modifying the target resource according to the modification instruction to obtain the target resource copy, accessing the target resource copy, and storing the target resource copy content file.

5. The method of claim 1, wherein storing the target resource copy content file comprises:
providing a store option comprising an option for storing the target resource copy content file and an option for not storing the target resource copy content file; and
in response to a selection instruction of the option for storing the target resource copy content file, storing the target resource copy content file.

6. The method of claim 1, wherein storing the target resource copy content file comprises:
determining modification setting for the target resource indicated by the modification instruction, and storing the modification setting as the target resource copy content file.

7. The method of claim 1, wherein storing the target resource copy content file comprises:
modifying the target resource according to the modification instruction to obtain the target resource copy, and storing the target resource copy as the target resource copy content file.

8. The method of claim 1, wherein
the access request for the target resource comprises a request for sharing the target resource.

9. The method of claim 1, wherein providing the access option comprises:
providing an original thumbnail as the option for accessing the target resource, and providing a copy thumbnail as the option for accessing the target resource copy; the original thumbnail comprising a thumbnail of the target resource, and the copy thumbnail comprising the original thumbnail and a preset copy mark.

10. The method of claim 1, wherein after providing the access option, the method further comprises:
in response to a selection instruction of the option for accessing the target resource, requesting for accessing the target resource; or
in response to a selection instruction of the option for accessing the target resource copy, accessing the target resource copy.

11. The method of claim 10, wherein in response to the selection instruction of the option for accessing the target resource, requesting for accessing the target resource comprises:
in response to the selection instruction of the option for accessing the target resource, acquiring the modification instruction for the target resource.

12. The method of claim 10, wherein
storing the target resource copy content file comprises: determining modification setting for the target resource indicated by the modification instruction, and storing the modification setting as the target resource copy content file; and
in response to the selection instruction of the option for accessing the target resource copy, accessing the target resource copy comprises: modifying the target resource according to the modification setting to obtain the target resource copy, and accessing the target resource copy.

13. A resource access control method, comprising:
storing a private information-removed copy and associating an original resource with the privacy information-removed copy by a common service entity, wherein a privacy information-removed resource is obtainable from the privacy information-removed copy, and the privacy information-removed resource is obtained by removing privacy information from an original resource; and
in response to an access request for the original resource, returning, by the common service entity, an option for accessing the original resource and an option for accessing the privacy information-removed resource.

14. The method of claim 13, wherein storing the private information-removed copy and associating the original resource with the privacy information-removed copy by the common service entity comprises:
in response to the access request for the original resource from a second application entity and an instruction for reserving the private information-removed copy acquired by a first application entity, acquiring the privacy information-removed resource obtained by the first application entity according to the instruction for reserving the private information-removed copy, returning the privacy information-removed resource to the second application entity, storing the private information-removed copy, and associating the original resource with the private information-removed copy, by the common service entity.

15. The method of claim 13, wherein in response to the access request for the original resource, returning, by the common service entity, the option for accessing the original resource and the option for accessing the privacy information-removed resource comprises:
in response to the access request for the original resource from a second application entity, returning, by the common service entity, the option for accessing the original resource and the option for accessing the privacy information-removed resource to the second application entity.

16. The method of claim 13, wherein
the option for accessing the original resource comprises the original resource and/or a resource associated with the original resource; and
the option for accessing the privacy information-removed resource comprises the privacy information-removed resource and/or a resource associated with the privacy information-removed resource.

17. The method of claim 16, wherein the option for accessing the privacy information-removed resource comprises:
a virtual privacy information-removed resource and an address of the privacy information-removed resource.

18. The method of claim 13, wherein the option for accessing the privacy information-removed resource comprises:
the privacy information-removed resource comprising an address of the privacy information-removed resource and a type of removed privacy information resource.

19. The method of claim 13, wherein after in response to the access request for the original resource, returning, by the common service entity, the option for accessing the original resource and the option for accessing the privacy information-removed resource, the method further comprises:
in response to selection of the option for accessing the original resource, returning, by the common service entity, the original resource; or
in response to selection of the option for accessing the privacy information-removed resource, returning, by the common service entity, the privacy information-removed resource.

20. The method of claim 19, wherein the private information-removed copy comprises the privacy information-removed resource;
storing the private information-removed copy and associating the original resource with the privacy information-removed copy by the common service entity comprises: in response to the access request for the original resource from a second application entity and an instruction for reserving the private information-removed copy acquired by a first application entity, acquiring the privacy information-removed resource obtained by the first application entity according to the instruction for reserving the private information-removed copy, returning the privacy information-removed resource to the second application entity, storing the privacy information-removed resource as the private information-removed copy, and associating the original resource with the private information-removed resource, by the common service entity; and
in response to the selection of the option for accessing the privacy information-removed resource, returning, by the common service entity, the privacy information-removed resource comprises: in response to the second application entity's selection of the option for accessing the privacy information-removed resource, returning, by the common service entity, the privacy information-removed resource.

21. The method of claim 19, wherein the private information-removed copy comprises removal setting in the instruction for reserving the private information-removed copy; and
storing the private information-removed copy and associating the original resource with the privacy information-removed copy by the common service entity comprises: in response to the access request for the original resource from a second application entity and an instruction for reserving the private information-removed copy acquired by a first application entity, acquiring the privacy information-removed resource obtained by the first application entity according to the instruction for reserving the private information-removed copy, returning the privacy information-removed resource to the second application entity and then deleting the privacy information-removed resource, storing the removal setting in the instruction for reserving the private information-removed copy as the private information-removed copy, and associating the original resource with the removal setting, by the common service entity; and
in response to the selection of the option for accessing the privacy information-removed resource, returning, by the common service entity, the privacy information-removed resource comprises: in response to the second application entity's selection of the option for accessing the privacy information-removed resource, sending the removal setting to the first application entity, acquiring the privacy information-removed resource which is obtained by the first application entity according the removal setting; returning the privacy information-removed resource to the second application entity and then deleting the privacy information-removed resource, by the common service entity.

22. (canceled)

23. (canceled)
